(19) United States
(12) Patent Application Publication
(10) Pub. No.: US 2026/0099996 A1
(43) Pub. Date: Apr. 9, 2026

(54) GENERATING THREE-DIMENSIONAL (3D) REPRESENTATIONS USING GAUSSIAN SPLATTING

(71) Applicant: QUALCOMM Incorporated, San Diego, CA (US)

(72) Inventors: Yan DENG, La Jolla, CA (US); Chieh-Ming KUO, Taoyuan (TW); Ze ZHANG, San Diego, CA (US); Michel Adib SARKIS, San Diego, CA (US); Ning BI, San Diego, CA (US); Matthew FISCHLER, San Diego, CA (US); Matthew Felsobuki NAGY, Irvine, CA (US)

(21) Appl. No.: 19/190,267

(22) Filed: Apr. 25, 2025

Related U.S. Application Data
(60) Provisional application No. 63/705,438, filed on Oct. 9, 2024.

(51) Int. Cl. G06T 17/00; G06T 7/12

(52) U.S. Cl. CPC G06T 17/00; G06T 7/12

(57) ABSTRACT

Systems and techniques are described herein for generating three-dimensional (3D) representations. For instance, a method for generating three-dimensional (3D) representations is provided. The method may include generating a Gaussian-splat representation of a subject based on a point-cloud representation of the subject; and iteratively adjusting the Gaussian-splat representation and a mask indicative of Gaussian splats of the Gaussian-splat representation to render images by rendering images based on the Gaussian-splat representation and the mask, comparing the rendered images to input images of the subject, and adjusting parameters of the Gaussian-splat representation and values of the mask based on the comparison.

### CROSS-REFERENCE TO RELATED APPLICATIONS

This application claims the benefit of U.S. Provisional Application No. 63/705,438, filed Oct. 9, 2024, which is incorporated herein by reference in its entirety.

### TECHNICAL FIELD

The present disclosure generally relates to generating three-dimensional (3D) representations. For example, aspects of the present disclosure include systems and techniques for generating 3D representations using Gaussian splatting.

### BACKGROUND

Various techniques have been used to generate three-dimensional (3D) digital representations of scenes, objects, people, etc. Such techniques include generating 3D meshes, neural radiance fields (NeRFs), Gaussian Splatting, among others.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating three-dimensional (3D) representations. According to at least one example, a method is provided for generating 3D representations. The method includes: generating a Gaussian-splat representation of a subject based on a point-cloud representation of the subject; and iteratively adjusting the Gaussian-splat representation and a mask indicative of Gaussian splats of the Gaussian-splat representation to render images by rendering images based on the Gaussian-splat representation and the mask, comparing the rendered images to input images of the subject, and adjusting parameters of the Gaussian-splat representation and values of the mask based on the comparison.

In another example, an apparatus for generating 3D representations is provided that includes at least one memory and at least one processor (e.g., configured in circuitry) coupled to the at least one memory. The at least one processor configured to: generate a Gaussian-splat representation of a subject based on a point-cloud representation of the subject; and iteratively adjust the Gaussian-splat representation and a mask indicative of Gaussian splats of the Gaussian-splat representation to render images by rendering images based on the Gaussian-splat representation and the mask, comparing the rendered images to input images of the subject, and adjusting parameters of the Gaussian-splat representation and values of the mask based on the comparison.

In another example, a non-transitory computer-readable medium is provided that has stored thereon instructions that, when executed by one or more processors, cause the one or more processors to: generate a Gaussian-splat representation of a subject based on a point-cloud representation of the subject; and iteratively adjust the Gaussian-splat representation and a mask indicative of Gaussian splats of the Gaussian-splat representation to render images by rendering images based on the Gaussian-splat representation and the mask, comparing the rendered images to input images of the subject, and adjusting parameters of the Gaussian-splat representation and values of the mask based on the comparison.

In another example, an apparatus for generating 3D representations is provided. The apparatus includes: means for generating a Gaussian-splat representation of a subject based on a point-cloud representation of the subject; and means for iteratively adjusting the Gaussian-splat representation and a mask indicative of Gaussian splats of the Gaussian-splat representation to render images by rendering images based on the Gaussian-splat representation and the mask, comparing the rendered images to input images of the subject, and adjusting parameters of the Gaussian-splat representation and values of the mask based on the comparison.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example system for generating Gaussian splats;

FIG. 2 is a diagram illustrating an example system for generating 3D representations (e.g., Gaussian splats), according to various aspects of the present disclosure;

FIG. 3 is a diagram illustrating an example system for generating 3D representations (e.g., Gaussian splats), according to various aspects of the present disclosure;

FIG. 4 is a diagram illustrating an example system for generating 3D representations (e.g., Gaussian splats), according to various aspects of the present disclosure;

FIG. 5 is a diagram illustrating an example system for generating 3D representations (e.g., Gaussian splats), according to various aspects of the present disclosure;

FIG. 6 is a diagram illustrating an example system for generating 3D representations (e.g., Gaussian splats), according to various aspects of the present disclosure;

FIG. 7 is a block diagram illustrating a system for storing and using data representing 3D representations (e.g., Gaussian splats);

FIG. 8 is a block diagram illustrating a system for storing and using data representing 3D representations (e.g., Gaussian splats), according to various aspects of the present disclosure;

FIG. 9 is a block diagram illustrating a system for generating images according to various aspects of the present disclosure;

FIG. 10 is a flow diagram illustrating an example process for generating 3D representations (e.g., Gaussian splats), in accordance with aspects of the present disclosure;

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Gaussian splatting is a technique for generating a digital three-dimensional (3D) representation of a scene, object, person, etc. Gaussian splatting involves generating 3D Gaussian splats (e.g., oblate, spherical, or prolate spheroids) to represent the scene, object, person, etc. based on images of the scene, object, person, etc. through an iterative gradient-descent process.

One drawback of conventional gaussian splatting is that conventional gaussian splatting may generate a large number of primitives. The number of primitives may lead to extra memory occupancy and result in relatively long rendering times.

Systems, apparatuses, methods (also referred to as processes), and computer-readable media (collectively referred to herein as “systems and techniques”) are described herein for generating three-dimensional (3D) representations (e.g., of objects, people, scenes, etc.). For example, the systems and techniques described herein may include a semantic-mask-based gaussian-splatting training technique in which a mask can be trained and across dynamic and/or relighting frames of the same subject. The technique can be utilized in both a forward and a backward Gaussian-splatting framework. The systems and techniques may, additionally or alternatively, include a mask-based relightable Gaussian-splatting technique that may be able to generate sparse relightable gaussian-splatting avatars.

Various aspects of the application will be described with respect to the figures below.

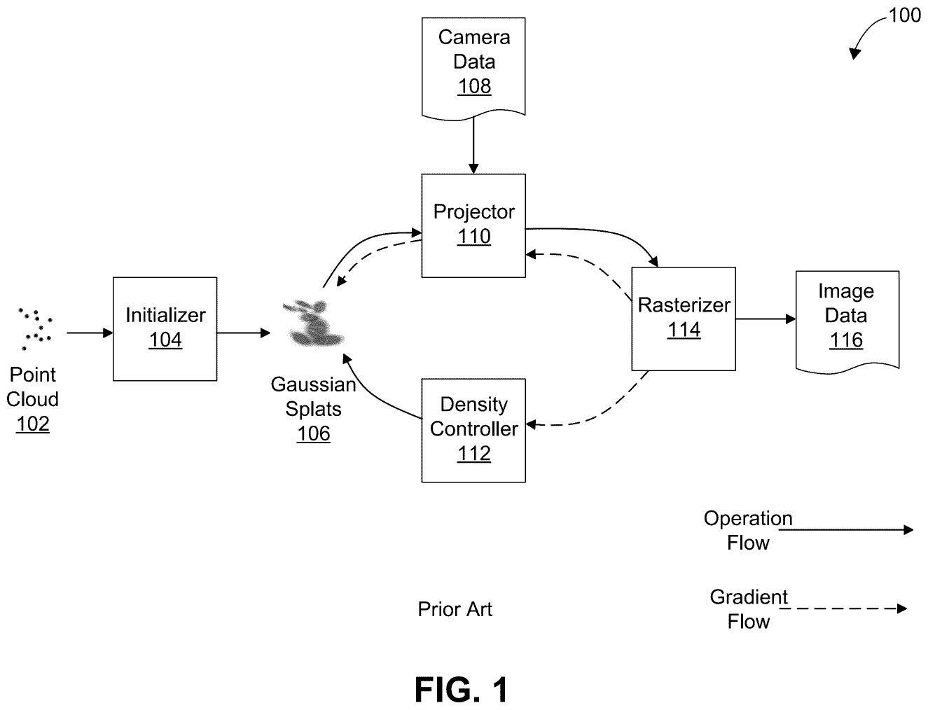

FIG. 1 is a diagram illustrating an example system 100 for generating Gaussian splats 106. In general, system 100 may be provided with a point cloud 102. For example, a camera may capture a number of images of a scene, object, person, etc. The number of images may be processed, for example, according to a structure from motion (SfM) technique, to generate a point-cloud representation (e.g., point cloud 102) of the scene, object, person, etc.

An initializer 104 may generate Gaussian splats 106 based on point cloud 102. For example, for each point in point cloud 102, initializer 104 may generate a Gaussian splat.

In the present disclosure, the term “Gaussian splat” may refer to a shape (e.g., an oblate, spherical, or prolate spheroid) that is used as part of a representation of a 3D object, person, scene, etc. In the present disclosure, the term “Gaussian splats” may refer to more than one Gaussian splat. Additionally, the term “Gaussian splats” may refer to a 3D representation made up of Gaussian splats.

System 100 may iteratively adjust Gaussian splats 106 to cause Gaussian splats 106 to better and better represent the scene, object, person, etc. For example, projector 110 may project Gaussian splats 106 based on camera data 108 (which may include positions from which images of the scene, object, person, etc. were captured. Additionally, rasterizer 114 may rasterize the projected Gaussian splats into an image plane to generate image data 116. System 100 may compare image data 116 with the images on which point cloud 102 is based. Further, system 100 may adjust Gaussian splats 106 according to a gradient-descent technique such that in further iterations of the iterative process, Gaussian splats 106 better represents the scene, object, person, etc. captured in the input images. Additionally, density controller 112 may determine which splats to use.

A conventional training strategy for gaussian splatting may (e.g., as illustrated and described with regard to FIG. 1) may include obtaining a point cloud (e.g., point cloud 102). The point cloud may be obtained from, for example, COLMAP, which is a general-purpose Structure-from-Motion (SfM) and Multi-View Stereo (MVS) pipeline with a graphical and command-line interface. The point cloud may be a reconstruction based on multi-view images.

For gaussian initialization, conventional training strategy may directly initialize gaussian position with the point clouds from COLMAP. Each Gaussian splat (which may alternatively be referred to as a “primitive”) may include parameters including a position (e.g., position of the Gaussian splat in a 3D space), a scale (e.g., a size of the Gaussian splat), an opacity (e.g., describing how opaque or translucent the Gaussian splat is), a rotation (e.g., orientation of the Gaussian splat), and a color (e.g., a color of the Gaussian splat). The conventional training strategy may try to optimize the parameters of the Gaussian splats to map to the real image. The resulting Gaussian splats can be used as 3D representation.

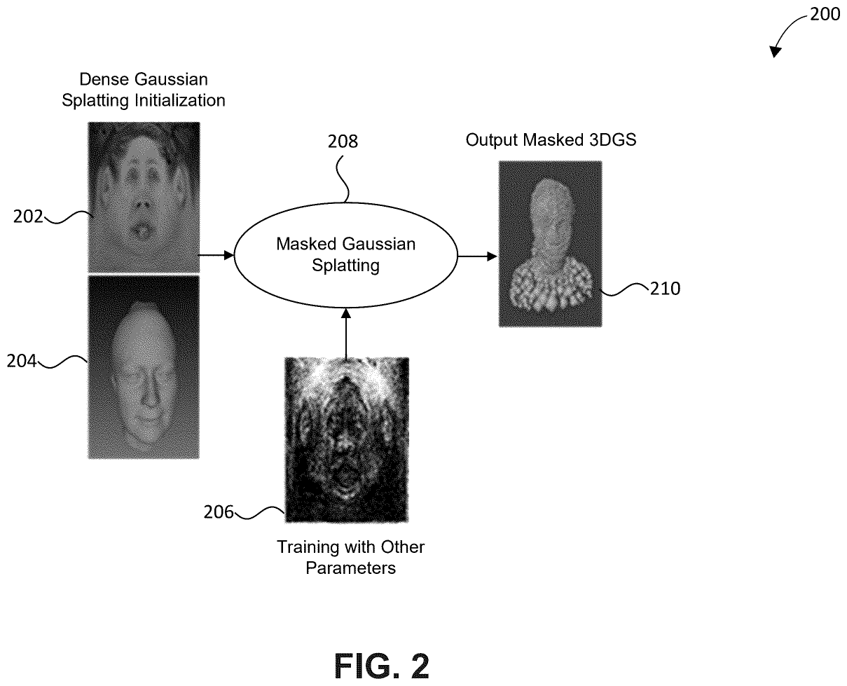

FIG. 2 is a diagram illustrating an example system 200 for generating 3D representations (e.g., masked Gaussian splats 210), according to various aspects of the present disclosure. In general, system 200 may obtain a UV map 202 and a 3D mesh 204. As system 200 iteratively generates masked Gaussian splats 208, system 200 may also iteratively generate mask 206. In some aspects, 206//may have semantic meaning, for example, points of 206//may have annotations.

UV map 202 may be a UV map based on a plurality of images of a head of a person (as an example). The letters “U” and “V” denote the axes of UV map 202 because “X”, “Y”, and “Z” denote the axes of the 3D object in model space (e.g., in the space of 3D mesh 204). 3D mesh 204 may be, or may include, a 3D model of the head of the person.

Mask 206 may be a mask of Gaussian splats. For example, mask 206 may indicate which Gaussian splats of a number of Gaussian splats to use to render images. System 200 may iteratively generate masked Gaussian splats 208 and mask 206 through an iterative gradient-descent process. Masked Gaussian splats 210 may represent Gaussian splats after the process of generating masked Gaussian splats 208 and mask 206.

3D mesh 204 and UV map 202 may be based on multiple images (e.g., enrollment images) of a head of a user. For example, a warp face template may be fit the multiple images. The warp face template (e.g., 4-dimensional (4D) face), may be, or may include, a mesh (e.g., 3D mesh 204) and texture (e.g., UV map 202).

3D point clouds may be directly sampled from the warp face template. Each 3D position may correspond to a UV position in the texture image (UV map 202). The color may also be directly inherited from UV map 202.

Each UV point (e.g., each point in UV map 202), is treated as a Gaussian splat. Each Gaussian splat may have parameters including a position (UV point), a mask, a scale, a rotation, an opacity and a color. System 200 may try to optimize the Gaussian splats and the mask to match the multiple images via a camera matrix.

In addition to generating masked Gaussian splats 210 (which may be trained on neutral expressions), system 200 may generate a semantic mask 206 which can be used across the same subject with different expression or relighting.

To generate images of the subject with other expressions, the training process need not be repeated. Rather, to generate images of the subject with other expressions, the systems and techniques may fit the mesh template to other expression, sampling the point clouds on UV map 202, sub-sample the point based on the resulted mask, and train the Gaussian splatting.

During training (e.g., the iterative process of generating masked Gaussian splats 208 and mask 206), mask 206 may be trained to control whether Gaussian splats of masked Gaussian splats 208 are used in rendering images, or not. System 200 may train masked Gaussian splats 208 according to:

$${M}_{n} = sg ( 𝕀 [ σ ( {m}_{n} ) > ϵ ] - σ ( {m}_{n} ) ) + σ ( {m}_{n} )$$

where Mₙ represents a mask including a number of mask points,
where mₘ and mₙ represent points of Mₙ,
where sg represents a sigmoid function,
where [symbol] represents an identify function,
where σ represents dirac delta function, and
where ϵ represents a threshold.

$${\hat{s}}_{n} = {M}_{n} {s}_{n}$$

$${\hat{o}}_{n} = {M}_{n} {o}_{n}$$

where Ŝₙ represents masked scale of gaussian splats,
where Mₙ represents a mask including a number of mask points,
where sₙ represents scale of gaussian splats,
where ôₙ represents masked opacities of gaussian splats, and
where oₙ represents opacities of gaussian splats.

The above expressions are written in in a differentiable format so that the mask 206 and/or masked Gaussian splats 208 can be improved through a gradient-descent approach.

Additionally, system 200 may enforce a mask-based regularization to control sparsity via tuning the learning rate according to:

$${L}_{m} = \frac{1}{N} {\sum }_{n = 1}^{N} σ ( {m}_{n} )$$

where Lₘ represents the loss,
where N represents the number of points in Mₙ
where σ represents dirac delta function, and
where mₘ and mₙ represent points of Mₙ.

$$ℒ = ( 1 - λ ) {ℒ}_{1} + {L}_{D - SSIM}$$

where [symbol] represents the loss,
where λ is a hyperparameter,
where [symbol] ₁ represents a loss function, and
where [symbol] _{D-SSIM} represents a data structural similarity index measure loss.

The first loss expression may encourage mask 206 to adjust masked Gaussian splats 208 to be sparser (e.g., include fewer points than an initial point cloud). The second loss expression may cause images rendered based on masked Gaussian splats 210 to be similar to enrollment images.

Additionally, system 200 may prune masked Gaussian splats 208 based on mask 206. The resulting mask will take both scale and opacity into consideration.

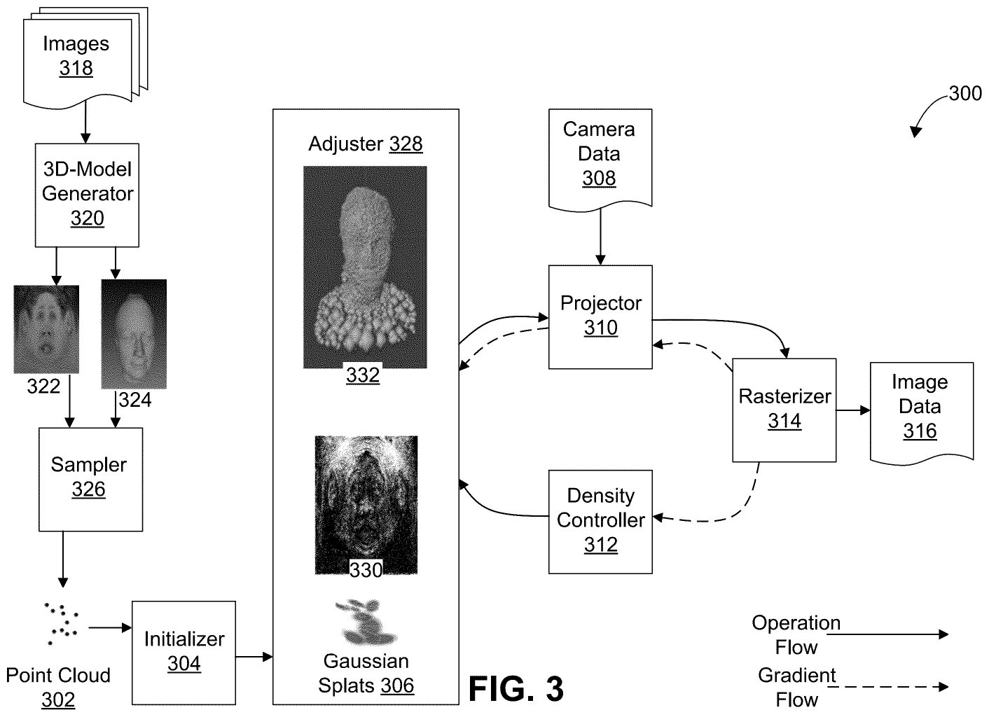

FIG. 3 is a diagram illustrating an example system 300 for generating 3D representations (e.g., Gaussian splats 332), according to various aspects of the present disclosure. In general, system 300 may obtain images 318, a 3D-model generator 320 may generate a UV map 322 and a 3D mesh 324 based on images 318. A sampler 326 may generate point cloud 302 based on UV map 322 and 3D mesh 324. An initializer 304 may generate Gaussian splats 306 based on point cloud 302. An adjuster 328 may filter Gaussian splats 306 based on mask 330 to generate Gaussian splats 332. A projector 310 may project filtered Gaussian splats 332 based on camera data 308 and a rasterizer 314 may rasterize the projected Gaussian splats 306 to generate image data 316. Through an iterative process, using gradient descent, system 300 may adjust Gaussian splats 332 and mask 330 such that image data 316 appears similar to images 318.

Images 318 may be, or may include, images of a subject (e.g., a scene, an object, a person, etc.) capture from multiple viewpoints. Images 318 may be multiview enrollment images.

3D-model generator 320 may generate UV map 322 and 3D mesh 324 based on images 318. 3D-model generator 320 may be, or may implement, template-based multi-view avatar reconstruction.

UV map 322 may be, or may include, a UV map including color data (e.g., red, green blue (RGB) data). Each pixel of UV map 322 (which may be referenced according to a UV coordinate system) may map to a 3D point (e.g., of 3D mesh 324).

3D mesh 324 may be, or may include, a 3D model of the subject. 3D mesh 324 may be, or may include, a mesh model of the subject.

Sampler 326 may sample UV map 322 and/or 3D mesh 324 to generate point cloud 302. Point cloud 302 may include a number of points in a 3D space.

Initializer 304 may generate Gaussian splats 306 based on point cloud 302. For example, initializer 304 may generate one Gaussian splat for each point of point cloud 302.

Gaussian splats 306 may be, or may include, a number of individual Gaussian splats. Each Gaussian splat may include parameters including a position, a rotation, a scale, a color, and an opacity.

A djuster 328 may filter Gaussian splats 306 based on mask 330. For example, adjuster 328 may cause some of Gaussian splats 306 to be not projected and/or rendered in image data 316. For example, adjuster 328 may mark certain ones of Gaussian splats 306 as invisible based on mask 330.

M ask 330 may be two-dimensional map of values that corresponds to UV map 322 and/or 3D mesh 324. For example, each value of mask 330 may map to a point of UV map 322 and a point of 3D mesh 324. M ask 330 may map to 3D mesh 324 in the same way that UV map 322 maps to 3D mesh 324. Thus, mask 330 may correspond to UV map 322. In some aspects, mask 330 may be a binary mask in which for a given value, a 1 indicates that a Gaussian splat corresponding to the given value is to be rendered in an image and a 0 indicates that a Gaussian splat corresponding to the give value is not to be rendered in the image. Gaussian splats 332 represents Gaussian splats 306 as filtered by mask 330.

Through an iterative gradient-descent process, system 300 may iteratively adjust mask 330 and Gaussian splats 332 so that images rendered based on Gaussian splats 332 are more similar to images 318. To adjust Gaussian splats 332, adjuster 328 may adjust any or all of a position, a rotation, a scale, a color, and an opacity of any or all of Gaussian splats 332. To adjust mask 330, adjuster 328 may adjust which ones of Gaussian splats 332 are to be used to render image data 316 and which are not.

For example, projector 310 may project Gaussian splats 332 based on camera data 308. Camera data 308 may include positions (e.g., in coordinates that can be related to 3D mesh 324, Gaussian splats 306, and/or Gaussian splats 332) from which images 318 were captured. Projector 310 may project Gaussian splats 332 and rasterizer 314 may rasterize the projected Gaussian splats 332 (e.g., in an image plane) to generate image data 316. System 300 may compare image data 316 to images 318 and determine adjustments to make to Gaussian splats 332 and to mask 330 such that further iterations of the iterative process result in image data 316 that are more similar to images 318 (e.g., according to an iterative gradient-descent process). Additionally, density controller 312 may filter unwanted splats based on a learned mask.

As described above, while iteratively generating mask 330, system 300 may adjust mask 330 according to:

$${M}_{n} = sg ( 𝕀 [ σ ( {m}_{n} ) > ϵ ] - σ ( {m}_{n} ) ) + σ ( {m}_{n} )$$

$${\hat{s}}_{n} = {M}_{n} {s}_{n}$$

$${\hat{o}}_{n} = {M}_{n} {o}_{n}$$

and determine a loss according to:

$${L}_{m} = \frac{1}{N} {\sum }_{n = 1}^{N} σ ( {m}_{n} )$$

Adjuster 328 may adjust mask 330 based on scale and opacity of Gaussian splats 332. For example, adjuster 328 may adjust mask 330 such that very small and/or very transparent Gaussian splats are filtered (e.g., not used to generate images).

Generating a mask (e.g., mask 330 of FIG. 3 and/or mask 206 of FIG. 2), for example, iteratively while generating Gaussian splats (e.g., Gaussian splats 332 of FIG. 3 and/or masked Gaussian splats 208 of FIG. 2), may allow a stored Gaussian-splat representation to include fewer Gaussian splats than an initial Gaussian-splat representation which may be generated based on a point cloud. Thus, system 200 and system 300 may reduce a size of a stored Gaussian-splat representation. Additionally, the stored Gaussian splats may represent the subject with substantially the same fidelity as larger Gaussian-splat representation because the mask may be iteratively generated such that the masked Gaussian-splat representation can be projected and rasterized to generate images that are substantially similar to the input images. Thus, the masked Gaussian-splat representation may be iteratively generated through back propagation with at least one of the same goals (e.g., the same loss function) a larger Gaussian-splat representation is iteratively generated.

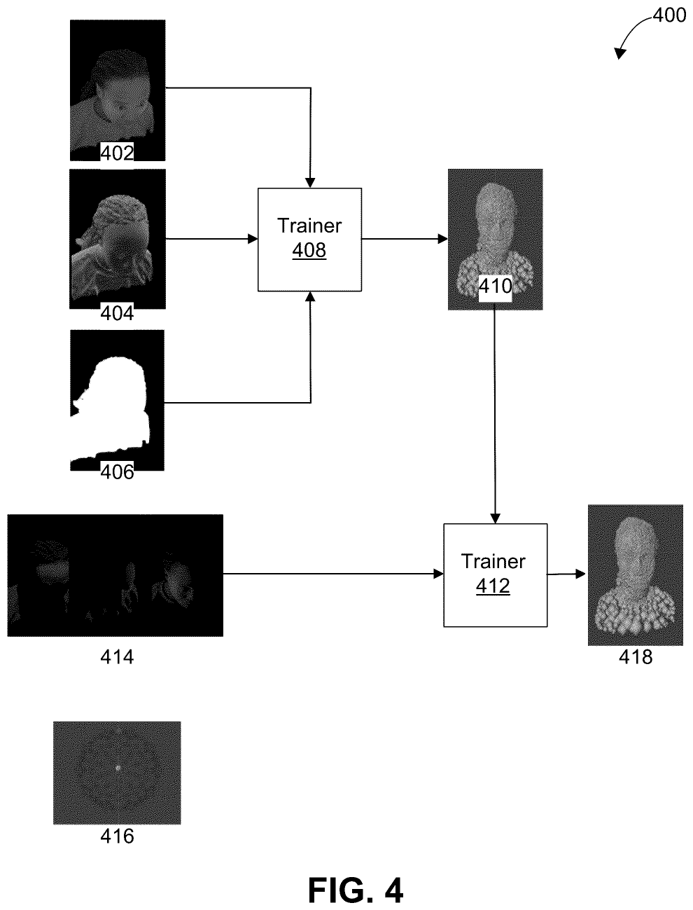

FIG. 4 is a diagram illustrating an example system 400 for generating 3D representations (e.g., Gaussian splats 418), according to various aspects of the present disclosure. For example, system 400 may train (e.g., iteratively generate according to a back-propagation process) a relightable Gaussian splat. System 400 may train the relightable Gaussian splat in two stages.

In the first stage, trainer 408 of system 400 may train a mask-based Gaussian geometry net (e.g., Gaussian splats 410). For example, trainer 408 may fit a mesh template based on enrollment images. Further, trainer 408 may sample point clouds on UV and subsample the point cloud based on a resulting mask (neutral expression) as described with regard to FIG. 2 and FIG. 3.

Trainer 408 may train the geometry-aware gaussian (e.g., Gaussian splats 410). Each Gaussian splat of Gaussian splats 410 may have a position, a rotation, a scale, a color, an opacity and a normal. In the present disclosure, the term “normal” may refer to a vector. A normal may be directed normal (or perpendicular) to a surface. Trainer 408 may train Gaussian splats 410 according to the following cost functions:

$$Dist ( rendered\_image * image\_mask , ground\_truth \_image * image\_mask )$$

$$and$$

$$Dist ( rendered\_normal * image\_mask , ground\_truth \_normal * image\_mask ) ,$$

where Dist represents an image comparison function, such as a geometric-distance function,
where rendered_image represents an image rendered based on Gaussian splats 410,
where image_mask represents mask 406 based on the view from which rendered_image is rendered,
where ground_truth_image represents an enrollment image corresponding to rendered_image (e.g., captured from the same viewpoint as the viewpoint from which rendered_image is rendered),
where rendered_normal represents normal 404,
where ground_truth_normal represents a normal determined based on the enrollment image corresponding to rendered_image.

System 400 may treat normal similar to color. For example, trainer 408 may generate normal while trainer 408 generates Gaussian splats. To train the normal, system 400 uses a ground-truth normal used to train the normal parameters of Gaussian splats 410. Ground-truth images and image mask are generated based on enrollment images (e.g., multiview images).

Trainer 408 may generate Gaussian splats 410 through an iterative process (e.g., as described with regard to FIG. 2 and FIG. 3). In addition to generating mask 406 and the position, rotation, scale, color, and opacity of each Gaussian splat, trainer 408 may generate a normal for each Gaussian splat.

In the first stage, geometry-aware Gaussian splats 410 are trained so that the splats are more regulated. The normals of each of the Gaussian splats can be used for specular rendering. Each Gaussian splat of Gaussian splats 410 may have a position, a rotation, a scale, a color, an opacity and a normal.

The first stage may include a backward relightable Gaussian-splat fitting system (e.g., without a decoder).

Prior to the second stage, synthetic one-light-at-a-time (OLAT) data 414 is obtained. Synthetic OLAT data 414 may include images of the subject lit by various lights of a light cage 416. For example, synthetic OLAT data 414 may include images of the subject from 47 views lit by different subsets of 146 point lights (e.g., of light cage 416). For instance, the camera view and point light are aligned with lights and views of light cage 416.

In the second stage, system 400 may train a masked-based relightable Gaussian splat. For example, trainer 412 may use Gaussian splats 410 as an input, for example, as an initialization. The trained mask from the first stage may be directly used to train relightable in the second stage. The initial point clouds of the second stage may be sampled from Gaussian splats 410 via mask 406. Trainer 412 may generate Gaussian splats 418 such that each Gaussian splat of Gaussian splats 418 includes a position, a rotation, a scale, a color, an opacity, a normal, sphere harmonic coefficients, and albedo color. Thus, Gaussian splats 418 may include parameters including position, rotation, scale, color, opacity, normal, sphere harmonic coefficients, and albedo color. For example, each Gaussian splat of Gaussian splats 418 may include a position, a rotation, a scale, a color, an opacity, a normal, a set of sphere harmonic coefficients, and an albedo color.

During training, for each Gaussian splat, the color is calculated as follows:

$${c}_{k}^{diffuse} = {ρ}_{k} ⊙ {\int }_{{𝕊}^{2}} L ( {ω}_{i} ) ⊙ {d}_{k} ( {ω}_{i} ) d {ω}_{i} = {ρ}_{k} ⊙ {\sum }_{i = 1}^{{( n + 1 )}^{2}} {L}_{i} ⊙ {d}_{k}^{i}$$

where

$${c}_{k}^{diffuse}$$

represents color,
where k is index of gaussian,
where pₖ represents the albedo color of each gaussian,
where Lᵢ represents lighting sphere harmonic coefficient,
where ωᵢ represents area of surface, and
where

$${d}_{k}^{i}$$

is the sphere harmonic coefficient

In this way, trainer 412 may train (e.g., iteratively generate) a relightable representation of color. For example, trainer 412 may iteratively generate Gaussian splats 418, such that Gaussian splats 418 includes parameters (e.g., normal, sphere harmonic coefficients, and albedo color) that can be used to render the subject under different lighting conditions than the lighting conditions under which the enrollment images were captured.

When a new light comes, means different Lᵢ is given, Gaussian splats 418 can directly infer the color using trained rho and

$${d}_{k}^{i}$$

(sphere harmonic).

During inference, the color of Gaussian splats can be directly generated via the per Gaussian splat spherical harmonics and given light.

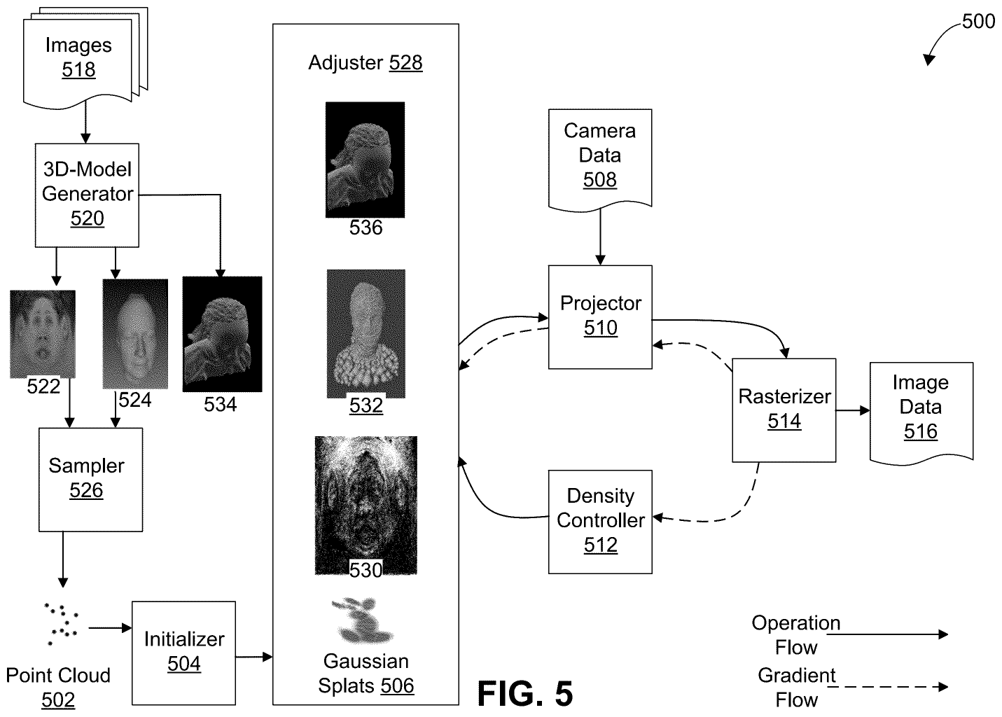

FIG. 5 is a diagram illustrating an example system 500 for generating 3D representations (e.g., Gaussian splats 532), according to various aspects of the present disclosure. System 500 is substantially similar to system 300 of FIG. 3. System 500 may be an example of trainer 408 of FIG. 4. For example, system 500 may implement the first stage of training of system 400 of FIG. 4.

For example, point cloud 502 may be the same as, or may be substantially similar to, point cloud 302. Initializer 504 may be the same as, may be substantially similar to, and/or may perform the same, or substantially the same, operations as initializer 304. Gaussian splats 506 may be the same as, or may be substantially similar to, Gaussian splats 306. Camera data 508 may be the same as, or may be substantially similar to, camera data 308. Projector 510 may be the same as, may be substantially similar to, and/or may perform the same, or substantially the same, operations as projector 310. Density controller 512 may be the same as, may be substantially similar to, and/or may perform the same, or substantially the same, operations as density controller 312. Rasterizer 514 may be the same as, or may be substantially similar to, rasterizer 314. Image data 516 may be the same as, or may be substantially similar to, image data 316. Images 518 may be the same as, or may be substantially similar to, images 318.

3D-model generator 520 may be the same as, may be substantially similar to, and/or may perform the same, or substantially the same, operations as 3D-model generator 320. Additionally, 3D-model generator 520 may generate ground-truth normals 534 based on images 518.

UV map 522 may be the same as, or may be substantially similar to, UV map 322. 3D mesh 524 may be the same as, or may be substantially similar to, 3D mesh 324. Sampler 526 may be the same as, may be substantially similar to, and/or may perform the same, or substantially the same, operations as sampler 326. M ask 530 may be the same as, or may be substantially similar to, mask 330. Gaussian splats 532 may be the same as, or may be substantially similar to, Gaussian splats 332.

Adjuster 528 may be substantially similar to adjuster 328. In addition to iteratively generating mask 530 and Gaussian splats 532, adjuster 528 may iteratively generate normals 536. Normals 536 may include a normal for each Gaussian splat of Gaussian splats 532. Each normal may be a vector.

Projector 510 and rasterizer 514, in generating image data 516 may generate image data 516 based on Gaussian splats 532, mask 530, and normals 536. For example, in rasterizing gaussian splats 532, rasterizer 514 may determine how light is reflected off gaussian splats 532 based, at least in part on normals 536.

System 500 may compare normals 536 with ground-truth normals 534 and adjust normals 536 such that in further iterations of the iterative process of generating normals 536, normals 536 are more similar to ground-truth normals 534. Additionally or alternatively, system 500 may compare image data 516 to images 518 and adjuster 528 may adjust normals 536 to cause image data 516 to be more similar to images 518 in further iterations of the iterative process of generating Gaussian splats 532, mask 530, and normals 536.

Although normals 536 are illustrated as a separate block from Gaussian splats 532, in some aspects, normals 536 may represent a parameter of Gaussian splats 532. For example, each Gaussian splat of Gaussian splats 532 may include a normal. Thus, normals 536 may be a part of Gaussian splats 532.

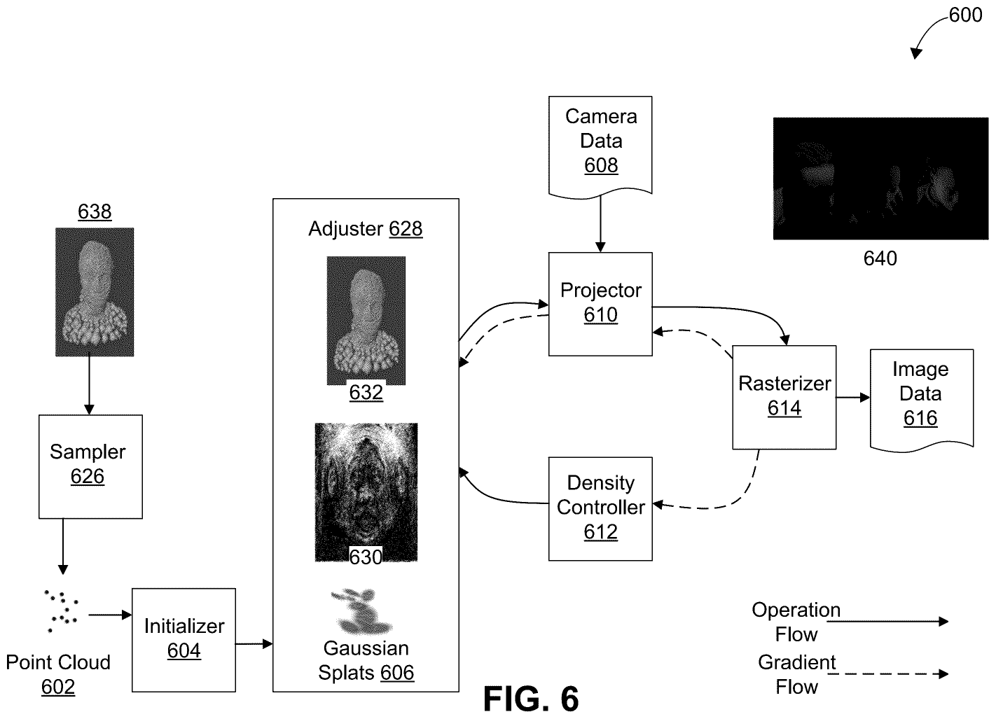

FIG. 6 is a diagram illustrating an example system 600 for generating 3D representations (e.g., Gaussian splats 632), according to various aspects of the present disclosure. System 600 is substantially similar to system 300 of FIG. 3. System 600 may be an example of trainer 412 of FIG. 4. For example, system 600 may implement the second stage of training of system 400 of FIG. 4.

For example, point cloud 602 may be the same as, or may be substantially similar to, point cloud 302. Initializer 604 may be the same as, may be substantially similar to, and/or may perform the same, or substantially the same, operations as initializer 304. Gaussian splats 606 may be the same as, or may be substantially similar to, Gaussian splats 306. Camera data 608 may be the same as, or may be substantially similar to, camera data 308. Projector 610 may be the same as, may be substantially similar to, and/or may perform the same, or substantially the same, operations as projector 310. Density controller 612 may be the same as, may be substantially similar to, and/or may perform the same, or substantially the same, operations as density controller 312. Rasterizer 614 may be the same as, or may be substantially similar to, rasterizer 314. Image data 616 may be the same as, or may be substantially similar to, image data 316. Sampler 626 may be the same as, may be substantially similar to, and/or may perform the same, or substantially the same, operations as sampler 326. M ask 630 may be the same as, or may be substantially similar to, mask 330.

Gaussian splats 638 may be an example of Gaussian splats 410 of FIG. 4 and/or a finished version of Gaussian splats 532 of FIG. 5. For example, system 600 may obtain Gaussian splats 638 (e.g., from a first stage of system 400, such as may be implemented by system 500).

Sampler 626 may generate point cloud 602 based on Gaussian splats 638. Initializer 604 may generate Gaussian splats 606 based on point cloud 602.

Image data 640 may be an example of synthetic OLAT data 414 of FIG. 4. For example, image data 640 may be generated based on a simulated subject in a light cage.

Adjuster 628 may iteratively adjust Gaussian splats 632 such that image data 616 (e.g., rendered based on Gaussian splats 632) are similar to image data 640 under similar simulated lighting conditions.

Gaussian splats 632 may include parameters including position, rotation, scale, color, opacity, normal, sphere harmonic coefficients, and albedo color. For example, each Gaussian splat of Gaussian splats 632 may include a position, a rotation, a scale, a color, an opacity, a normal, a set of sphere harmonic coefficients, and an albedo color.

Generating Gaussian splats based on and including normals, sphere harmonic coefficients, and/or albedo colors (e.g., as described with regard to FIG. 4, FIG. 5, and FIG. 6) may allow a Gaussian-splat representation to be relightable. For example, the Gaussian splats may be rendered under different lighting conditions than the lighting conditions under which the enrollment images of the subject were captured.

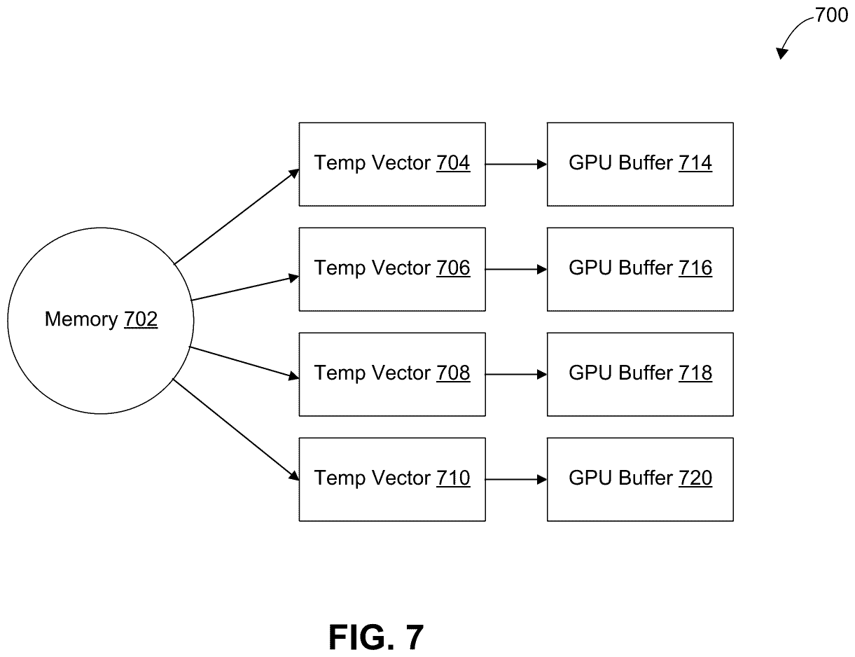

FIG. 7 is a block diagram illustrating a system 700 for storing and using data representing 3D representations (e.g., Gaussian splats). According to a conventional data storage-and-usage scheme, system 700 may store and read binary data in a single vector of structs, each vector containing the data of a single Gaussian splat that would need to be separated out into four separate vectors that were declared in-function and then copied to the corresponding GPU buffers. For example, system 700 may store values from memory 702 in temporary vectors (e.g., temporary vector 704, temporary vector 706, temporary vector 708, and temporary vector 710). Data from each of the temporary vectors may be copied into a corresponding GPU buffer (e.g., GPU buffer 714, GPU buffer 716, GPU buffer 718, and GPU buffer 720). For example, according to the conventional data storage-and-usage scheme, a Gaussian-splat representation may be stored in memory in such a way that the data required additional transformation before being usable by the GPU. That additional transformation had latency costs from allocating relatively substantial amounts of temporary memory and from processing the data.

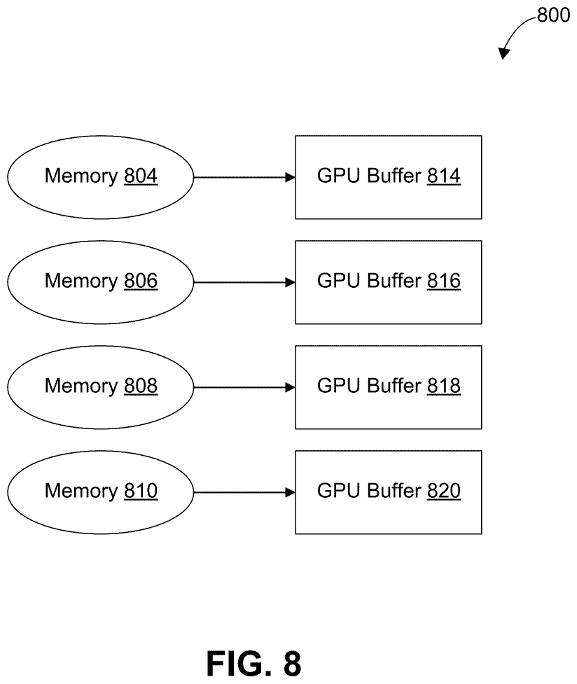

FIG. 8 is a block diagram illustrating a system 800 for storing and using data representing 3D representations (e.g., Gaussian splats), according to various aspects of the present disclosure. An improved data storage-and-usage scheme, according to various aspects of the present disclosure, may restructure how Gaussian-splat representation is stored in memory prior to being accessed to send to the GPU and eliminated intermediate states involved in that transfer. For example, Gaussian-splat representation may be copied directly from memory (e.g., memory 804, memory 806, memory 808, and memory 810) to GPU buffers (e.g., GPU buffer 814, GPU buffer 816, GPU buffer 818, and GPU buffer 820) with no additional allocation or processing needed. As a result, the maximum frame rate achieved by the renderer roughly quadrupled, for example, as compared with the conventional data storage-and-usage scheme.

Additionally or alternatively, the systems and techniques may eliminate extraneous bytes in the binary format of Gaussian-splat representation. According to conventional data storage-and-usage schemes, frames (e.g., Gaussian-splat representations) used 160 bytes per Gaussian splat. After eliminating bytes that either stored unused data or data that was identical across all Gaussian splats, frames according to the improved data storage-and-usage scheme use 34 bytes per Gaussian splat. As a result, reading the equivalent frames from memory and transferring them from memory to GPU buffers are now both faster (e.g., 4×, or more, faster as compared with the conventional data storage-and-usage scheme). Also, frames saved to disk take less space (e.g., 70% or more less space as compared with the conventional data storage-and-usage scheme).

Additionally or alternatively, the systems and techniques may implement a single allocation of memory at startup shared between sequences of frames. According to conventional data storage-and-usage schemes, any time a new sequence of frames was selected to be rendered, memory would be reallocated. According to the improved data storage-and-usage scheme, memory is allocated at startup, with only the amount necessary to accommodate the case with the highest requirements and is reformatted and reused when switching between sequences. As a result, switching between different sequences of frames is faster as compared with the conventional data storage-and-usage scheme.

Additionally or alternatively, the systems and techniques may allocate and manage memory an improved way as compared with the conventional data storage-and-usage scheme. According to the conventional data storage-and-usage scheme, each subject had its own allocated memory which created significant delays when switching between subjects. According to the improved data storage-and-usage scheme, the systems and techniques dynamically calculate and allocate the amount of memory required exactly once at the start of runtime. The systems and techniques do not require any additional large-scale allocation. A single set of buffers and managed pointers are shared between all subjects. This allows all transitioning between subjects to be more seamless than is possible using the conventional data storage-and-usage scheme.

Additionally or alternatively, the systems and techniques may cause GPU shaders to input frame data in an improved way. According to the conventional data storage-and-usage scheme, the GPU shaders that do the initial processing of input buffers are designed to handle more general-purpose frame data (i.e. expected harmonics that weren't actually used). According to the improved data storage-and-usage scheme, the initial-processing shaders GPU are specialized based on the optimized binary format. As a result, less total memory is allocated per frame. This results in reduced application startup time and a reduction in latency when transferring frame data to GPU buffers as compared with the conventional data storage-and-usage scheme.

Additionally or alternatively, the systems and techniques may involve initializing shaders have been changed to accommodate and exploit a higher data-density format, resulting in reduced latency when transferring data to GPU, further reduction in required memory allocation, and greatly reduced initial loading time.

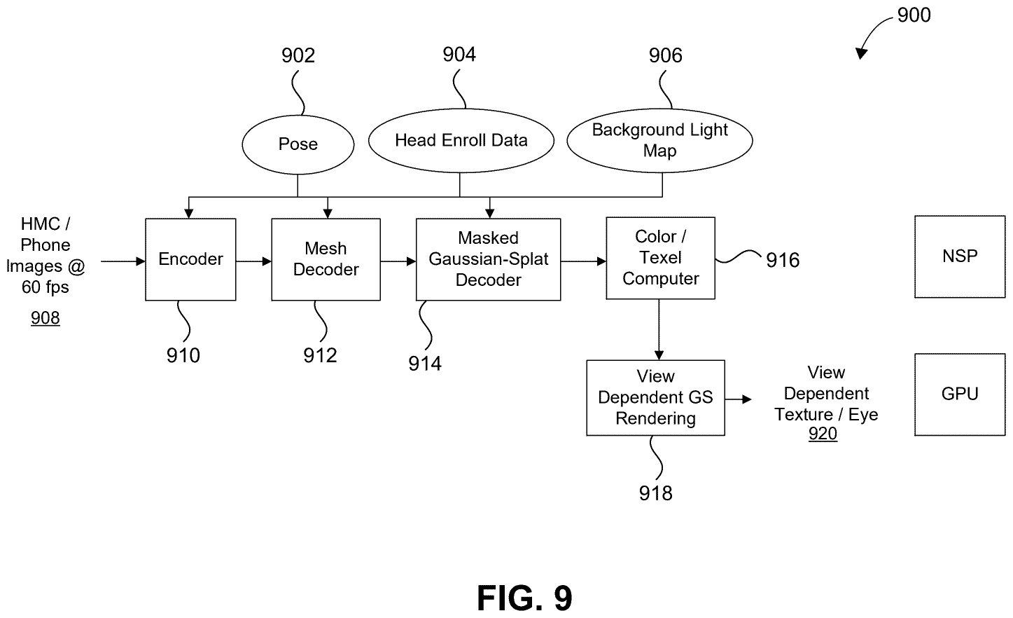

FIG. 9 is a block diagram illustrating an example system for generating image data, according to various aspects of the present disclosure. The systems and techniques may allow running on edge. For example, the systems and techniques may enable generation of 3D Gaussian-splat representations and/or rendering of images based on Gaussian-splat representations by edge devices (e.g., client devices, such as mobile devices, as compared with servers).

The systems and techniques may include generating a masked-based Gaussian-splat representation. The systems and techniques may include direct rendering via a calculated color instead of the conventional rendering from third-order spherical harmonics. The systems and techniques may train a mask-based Gaussian-splat relighting framework.

The systems and techniques may learn a user-specific mask. In some aspects, the systems and techniques may remove the task of computing spherical-harmonics coefficients from graphics processing unit (GPU). Instead, the systems and techniques may compute spherical-harmonics coefficients using a network on network signal processor (NSP). The NSP may share parameters (e.g., position, rotation, scale, color, and/or opacity) with the GPU. This may simplify the GPU buffer pipeline.

System 900 may obtain pose information 902 indicative of a pose (e.g., position and orientation) of a subject. Additionally, system 900 may obtain head-enroll data 904. Head-enroll data 904 may be, or may include, images of a head of the subject. Pose information 902 may be related to head-enroll data 904. For example, pose information 902 may describe poses of the subject in head-enroll data 904.

Additionally, system 900 may obtain background-light information 906. Background-light information 906 may be based on recovering the lighting sphere harmonic by given background light map.

An encoder 910 may obtain image data 908. Image data 908 may include multiple images obtained at a rate, such as 60 frames per second (fps). Image data 908 may be obtained, for example, from a phone or HMC. Encoder 910 may encode the expression information from image data 908.

A mesh decoder 912 may decode a mesh based on pose information 902 and head-enroll data 904.

A mask-Gaussian-splat decoder 914 may be, or may include, a decoder framework to directly generate the mask-based Gaussian splat, according to various aspects of the present disclosure.

A color/texel computer 916 may determine the color to be calculated based on light sphere harmonic and gaussian relighting parameters.

A view-dependent GS rendering 918 may render Gaussian splats based on color information and view information. View-dependent texture/eye 920 may be, or may include, view-dependent texture, such as shadow, specular related to relighting.

Encoder 910 and mesh decoder 912 may be implemented in a network signal processor (NSP). An NSP may be a processor configured to efficiently and/or quickly run inference operations using trained neural networks. View-dependent GS rendering 918 may be implemented in graphics processing unit (GPU). A GPU may be a processor configured to efficiently and/or quickly perform operations commonly performed in graphics processing.

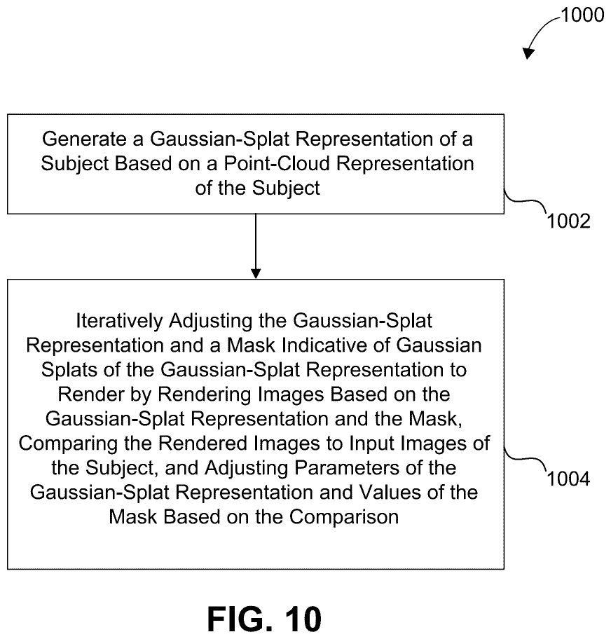

FIG. 10 is a flow diagram illustrating an example process 1000 for generating 3D representations (e.g., Gaussian splats), in accordance with aspects of the present disclosure. One or more operations of process 1000 may be performed by a computing device (or apparatus) or a component (e.g., a chipset, codec, etc.) of the computing device. The computing device may be a mobile device (e.g., a mobile phone), a network- connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1000. The one or more operations of process 1000 may be implemented as software components that are executed and run on one or more processors.

At block 1002, a computing device (or one or more components thereof) may generate a Gaussian-splat representation of a subject based on a point-cloud representation of the subject. For example, system 300 may generate gaussian splats 306 based on point cloud 302.

In some aspects, the computing device (or one or more components thereof) may generate the point-cloud representation of the subject based on the input images of the subject. For example, sampler 326 may generate point cloud 302 based on UV map 322 and 3D mesh 324 which are generated by d-model generator 320 based on images 318.

In some aspects, to generate the Gaussian-splat representation of the subject based on the point-cloud representation of the subject, the computing device (or one or more components thereof) may generate a Gaussian splat of the Gaussian-splat representation based on each point of the point-cloud representation. For example, initializer 304 may initialize gaussian splats 306 by generating a Gaussian splat based on each point of point cloud 302.

Atblock 1004, the computing device (or one or more components thereof) may iteratively adjust the Gaussian-splat representation and a mask indicative of Gaussian splats of the Gaussian-splat representation to render images by rendering images based on the Gaussian-splat representation and the mask, comparing the rendered images to input images of the subject, and adjusting parameters of the Gaussian-splat representation and values of the mask based on the comparison. For example, system 300 may iteratively adjust gaussian splats 332 and mask 330 by rendering image data 316 based on gaussian splats 332 and mask 330, comparing image data 316 to images 318, and adjusting parameters of gaussian splats 332 and mask 330 based on the comparison.

In some aspects, each Gaussian splat of the Gaussian-splat representation may be, or may include, position data, rotation data, scale data, color data, and opacity data. For example, each Gaussian splat of gaussian splats 332 may include parameters including position data, rotation data, scale data, color data, and opacity data.

In some aspects, each Gaussian splat of the Gaussian-splat representation comprises respective position data, rotation data, scale data, color data, opacity data and normal data indicative of a respective normal vector of each Gaussian splat. For example, each Gaussian splat of gaussian splats 532 may be, or may include, parameters including position data, rotation data, scale data, color data, opacity data and normal data indicative of a respective normal vector of each Gaussian splat. For example, gaussian splats 532 may be, or may include, normals 536.

In some aspects, the mask may be, or may include, a semantic mask related to a UV mask of the subject. For example, mask 330 may be, or may include, a semantic mask. In some aspects, each point of mask 330 may correspond to a point of UV map 322.

In some aspects, the Gaussian-splat representation and the mask are iteratively adjusted such that the rendered images are similar to the input images of the subject. For example, adjuster 328 may iteratively adjust gaussian splats 332 and system 300 such that image data 316 rendered based on gaussian splats 332 and mask 330 are similar to images 318.

In some aspects, the mask is iteratively adjusted to reduce a count of Gaussian splats of the Gaussian-splat representation used to render images. For example, adjuster 328 may iteratively adjust mask 330 to reduce a count of Gaussian splats of gaussian splats 332 that are used to render image data 316.

In some aspects, the parameters of the Gaussian-splat representation are adjusted according to a gradient-descent technique. For example, adjuster 328 may adjust gaussian splats 332 and mask 330 according to a gradient-descent technique.

In some aspects, the computing device (or one or more components thereof) may render additional images of the subject based on the Gaussian-splat representation of the subject. For example, having iteratively adjusted gaussian splats 332 and mask 330, system 300 may render output images based on gaussian splats 332 (and, in some cases, mask 330).

In some aspects, the additional images are rendered as if from different viewpoints than viewpoints from which the input images of the subject were captured. For example, the output images may be rendered as if from a different view point than the viewpoints from which images 318 were captured.

In some aspects, the Gaussian-splat representation may be a first Gaussian-splat representation. The rendered images may be first rendered images. The input images of the subject may be first input images of the subject. The computing device (or one or more components thereof) may generate a second Gaussian-splat representation based on the first Gaussian-splat representation; and iteratively adjust the second Gaussian-splat representation by rendering second rendered images based on the second Gaussian-splat representation, comparing the second rendered images to second input images of the subject, and adjusting parameters of the second Gaussian-splat representation based on the comparison. For example, trainer 408 may generate gaussian splats 410. To generate gaussian splats 410 trainer 408 may implement system 500 of FIG. 5. Additionally, trainer 412 may generate gaussian splats 418 based on gaussian splats 410. To generate gaussian splats 418 based on gaussian splats 410, trainer 412 may implement system 600 of FIG. 6. For example, sampler 626 may generate point cloud 602 based on gaussian splats 638 (which may be an example of gaussian splats 410) and initializer 604 may initialize gaussian splats 606 based on point cloud 602. System 600 may render image data 616 based on gaussian splats 632 and mask 630. Further, system 600 compare image data 616 to image data 640 (which may be an example of synthetic OLAT data 414) and iteratively adjust gaussian splats 632 and mask 630 based on the comparison, for example, such that in further iterations, image data 616 is more similar to image data 640.

In some aspects, the computing device (or one or more components thereof) may render additional images of the subject based on the second Gaussian-splat representation of the subject. For example, system 400 may render output images of the subject based on gaussian splats 418.

In some aspects, the additional images are rendered as if under different lighting conditions than lighting conditions in which the first input images of the subject were captured. For example, the output images rendered based on gaussian splats 418 may be rendered as if under different lighting conditions than the lighting conditions under which image 402 was captured.

In some aspects, the second input images of the subject are based on different lighting conditions than the first input images of the subject. For example, light cage 416 may be based on different lighting conditions than the lighting conditions under which images 402 was captured.

In some aspects, each Gaussian splat of the second Gaussian-splat representation may be, or may include, position data, rotation data, scale data, color data, opacity data, normal data indicative of a normal vector of the Gaussian splat, Albedo color data, and spherical harmonic data. For example, each Gaussian splat of gaussian splats 418 may be, or may include, parameters including position data, rotation data, scale data, color data, opacity data, normal data indicative of a normal vector of the Gaussian splat, Albedo color data, and spherical harmonic data.

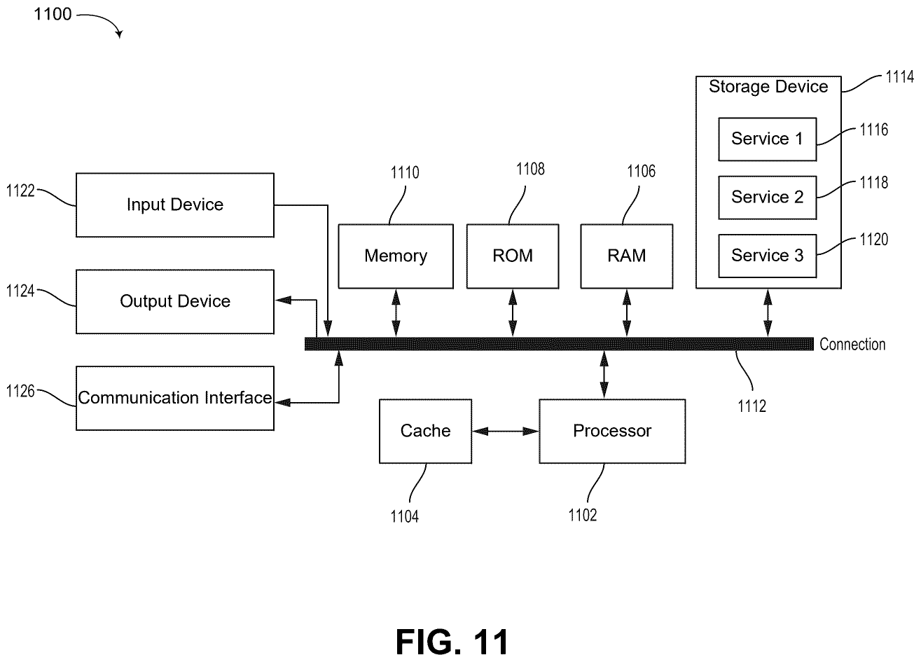

In some examples, as noted previously, the methods described herein (e.g., process 1000 of FIG. 10, and/or other methods described herein) can be performed, in whole or in part, by a computing device or apparatus. In one example, one or more of the methods can be performed by system 200 of FIG. 2, system 300 of FIG. 3, system 400 of FIG. 4, system 500 of FIG. 5, system 600 of FIG. 6, or by another system or device. In another example, one or more of the methods (e.g., process 1000, and/or other methods described herein) can be performed, in whole or in part, by the computing-device architecture 1100 shown in FIG. 11. For instance, a computing device with the computing-device architecture 1100 shown in FIG. 11 can include, or be included in, the components of the system 200, system 300, system 400, system 500, and/or system 600 and can implement the operations of process 1000, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1000, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1000, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of system 200 of FIG. 2, system 300 of FIG. 3, system 400 of FIG. 4, system 500 of FIG. 5, system 600 of FIG. 6, and/or other devices, modules, or systems described herein. Additionally or alternatively, computing-device architecture 1100 may be configured to perform process 1000, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. A n apparatus for generating three-dimensional (3D) representations, the apparatus comprising: at least one memory; and at least one processor coupled to the at least one memory and configured to: generate a Gaussian-splat representation of a subject based on a point-cloud representation of the subject; and iteratively adjust the Gaussian-splat representation and a mask indicative of Gaussian splats of the G aussian- splat representation to render images by rendering images based on the Gaussian-splat representation and the mask, comparing the rendered images to input images of the subject, and adjusting parameters of the Gaussian-splat representation and values of the mask based on the comparison.
Aspect 2. The apparatus of aspect 1, wherein the at least one processor is configured to render additional images of the subject based on the Gaussian-splat representation of the subject.
Aspect 3. The apparatus of aspect 2, wherein the additional images are rendered as if from different viewpoints than viewpoints from which the input images of the subject were captured.
Aspect 4. The apparatus of any one of aspects 1 to 3, at least one processor is configured to generate the point-cloud representation of the subject based on the input images of the subject.
Aspect 5. The apparatus of any one of aspects 1 to 4, wherein, to generate the Gaussian-splat representation of the subject based on the point-cloud representation of the subject, the at least one processor is configured to generate a Gaussian splat of the Gaussian-splat representation based on each point of the point-cloud representation.
Aspect 6. The apparatus of any one of aspects 1 to 5, wherein the mask comprises a semantic mask related to a UV mask of the subject.
Aspect 7. The apparatus of aspect 6, wherein points of the mask correspond to corresponding points of the UV mask of the subject.
Aspect 8. The apparatus of any one of aspects 1 to 7, wherein the Gaussian- splat representation and the mask are iteratively adjusted such that the rendered images are similar to the input images of the subject.
Aspect 9. The apparatus of any one of aspects 1 to 8, wherein the mask is iteratively adjusted to reduce a count of Gaussian splats of the Gaussian-splat representation to use to render images.
Aspect 10. The apparatus of any one of aspects 1 to 9, wherein each Gaussian splat of the Gaussian-splat representation comprises position data, rotation data, scale data, color data, and opacity data.
Aspect 11. The apparatus of any one of aspects 1 to 10, wherein the parameters of the Gaussian-splat representation are adjusted according to a gradient-descent technique.
Aspect 12. The apparatus of any one of aspects 1 to 11, wherein each Gaussian splat of the Gaussian-splat representation comprises respective position data, rotation data, scale data, color data, opacity data and normal data indicative of a respective normal vector of each Gaussian splat.
Aspect 13. The apparatus of aspect 12 wherein the Gaussian-splat representation comprises a first Gaussian-splat representation, wherein the rendered images comprise first rendered images, and wherein the input images of the subject comprise first input images of the subject, wherein the at least one processor is configured to: generate a second Gaussian-splat representation based on the first Gaussian-splat representation; and iteratively adjust the second Gaussian-splat representation by rendering second rendered images based on the second Gaussian-splat representation, comparing the second rendered images to second input images of the subject, and adjusting parameters of the second Gaussian-splat representation based on the comparison.
Aspect 14. The apparatus of aspect 13, wherein the at least one processor is configured to render additional images of the subject based on the second Gaussian-splat representation of the subject.
Aspect 15. The apparatus of aspect 14, wherein the additional images are rendered as if under different lighting conditions than lighting conditions in which the first input images of the subject were captured.
Aspect 16. The apparatus of any one of aspects 13 to 15, wherein the second input images of the subject are based on different lighting conditions than the first input images of the subject.
Aspect 17. The apparatus of any one of aspects 13 to 16, wherein each Gaussian splat of the second Gaussian-splat representation comprises position data, rotation data, scale data, color data, opacity data, normal data indicative of a normal vector of the Gaussian splat, Albedo color data, and spherical harmonic data.
Aspect 18. A method for generating three-dimensional (3D) representations, the method comprising: generating a Gaussian-splat representation of a subject based on a point-cloud representation of the subject; and iteratively adjusting the Gaussian-splat representation and a mask indicative of Gaussian splats of the Gaussian-splat representation to render images by rendering images based on the Gaussian-splat representation and the mask, comparing the rendered images to input images of the subject, and adjusting parameters of the Gaussian-splat representation and values of the mask based on the comparison.
Aspect 19. The method of aspect 18, further comprising rendering additional images of the subject based on the Gaussian-splat representation of the subject.
Aspect 20. The method of aspect 19, wherein the additional images are rendered as if from different viewpoints than viewpoints from which the input images of the subject were captured.
Aspect 21. The method of any one of aspects 18 to 20, further comprising generating the point-cloud representation of the subject based on the input images of the subject.
Aspect 22. The method of any one of aspects 18 to 21, wherein generating the Gaussian-splat representation of the subject based on the point-cloud representation of the subject comprises generating a Gaussian splat of the Gaussian-splat representation based on each point of the point-cloud representation.
Aspect 23. The method of any one of aspects 18 to 22, wherein the mask comprises a semantic mask related to a UV mask of the subject.
Aspect 24. The method of aspect 23, wherein points of the mask correspond to corresponding points of the UV mask of the subject.
Aspect 25. The method of any one of aspects 18 to 24, wherein the Gaussian-splat representation and the mask are iteratively adjusted such that the rendered images are similar to the input images of the subject.
Aspect 26. The method of any one of aspects 18 to 25, wherein the mask is iteratively adjusted to reduce a count of Gaussian splats of the Gaussian-splat representation used to render images.
Aspect 27. The method of any one of aspects 18 to 26, wherein each Gaussian splat of the Gaussian-splat representation comprises position data, rotation data, scale data, color data, and opacity data.
Aspect 28. The method of any one of aspects 18 to 27, wherein the parameters of the Gaussian-splat representation are adjusted according to a gradient-descent technique.
Aspect 29. The method of any one of aspects 18 to 28, wherein each Gaussian splat of the Gaussian-splat representation comprises respective position data, rotation data, scale data, color data, opacity data and normal data indicative of a respective normal vector of each Gaussian splat.
Aspect 30. The method of aspect 29 wherein the Gaussian-splat representation comprises a first Gaussian-splat representation, wherein the rendered images comprise first rendered images, and wherein the input images of the subject comprise first input images of the subject, the method further comprising: generating a second Gaussian-splat representation based on the first Gaussian-splat representation; and iteratively adjusting the second Gaussian-splat representation by rendering second rendered images based on the second Gaussian-splat representation, comparing the second rendered images to second input images of the subject, and adjusting parameters of the second Gaussian-splat representation based on the comparison.
Aspect 31. The method of aspect 30, further comprising rendering additional images of the subject based on the second Gaussian-splat representation of the subject.
Aspect 32. The method of aspect 31, wherein the additional images are rendered as if under different lighting conditions than lighting conditions in which the first input images of the subject were captured.
Aspect 33. The method of any one of aspects 30 to 32, wherein the second input images of the subject are based on different lighting conditions than the first input images of the subject.
Aspect 34. The method of any one of aspects 30 to 33, wherein each Gaussian splat of the second Gaussian-splat representation comprises position data, rotation data, scale data, color data, opacity data, normal data indicative of a normal vector of the Gaussian splat, Albedo color data, and spherical harmonic data.
Aspect 35. A non-transitory computer-readable storage medium having stored thereon instructions that, when executed by at least one processor, cause the at least one processor to perform operations according to any of aspects 18 to 34.
Aspect 36. A n apparatus for providing virtual content for display, the apparatus comprising one or more means for perform operations according to any of aspects 18 to 34.

What is claimed is:

1. An apparatus for generating three-dimensional (3D) representations, the apparatus comprising:
at least one memory; and
at least one processor coupled to the at least one memory and configured to:
generate a Gaussian-splat representation of a subject based on a point-cloud representation of the subject; and
iteratively adjust the Gaussian-splat representation and a mask indicative of Gaussian splats, of the Gaussian-splat representation to render images, by rendering images based on the Gaussian-splat representation and the mask, comparing the rendered images to input images of the subject, and adjusting parameters of the Gaussian-splat representation and values of the mask based on the comparison.

2. The apparatus of claim 1, wherein the at least one processor is configured to render additional images of the subject based on the Gaussian-splat representation of the subject.

3. The apparatus of claim 2, wherein the additional images are rendered as if from different viewpoints than viewpoints from which the input images of the subject were captured.

4. The apparatus of claim 1, at least one processor is configured to generate the point-cloud representation of the subject based on the input images of the subject.

5. The apparatus of claim 1, wherein, to generate the Gaussian-splat representation of the subject based on the point-cloud representation of the subject, the at least one processor is configured to generate a Gaussian splat of the Gaussian-splat representation based on each point of the point-cloud representation.

6. The apparatus of claim 1, wherein the mask comprises a semantic mask related to a UV mask of the subject.

7. The apparatus of claim 6, wherein points of the mask correspond to corresponding points of the UV mask of the subject.

8. The apparatus of claim 1, wherein the Gaussian-splat representation and the mask are iteratively adjusted such that the rendered images are similar to the input images of the subject.

9. The apparatus of claim 1, wherein the mask is iteratively adjusted to reduce a count of Gaussian splats of the Gaussian-splat representation to use to render images.

10. The apparatus of claim 1, wherein each Gaussian splat of the Gaussian- splat representation comprises position data, rotation data, scale data, color data, and opacity data.

11. The apparatus of claim 1, wherein the parameters of the Gaussian-splat representation are adjusted according to a gradient-descent technique.

12. The apparatus of claim 1, wherein each Gaussian splat of the Gaussian- splat representation comprises respective position data, rotation data, scale data, color data, opacity data and normal data indicative of a respective normal vector of each Gaussian splat.

13. The apparatus of claim 12, wherein the Gaussian-splat representation comprises a first Gaussian-splat representation, wherein the rendered images comprise first rendered images, and wherein the input images of the subject comprise first input images of the subject, wherein the at least one processor is configured to:
generate a second Gaussian-splat representation based on the first Gaussian-splat representation; and
iteratively adjust the second Gaussian-splat representation by rendering second rendered images based on the second Gaussian-splat representation, comparing the second rendered images to second input images of the subject, and adjusting parameters of the second Gaussian-splat representation based on the comparison.

14. The apparatus of claim 13, wherein the at least one processor is configured to render additional images of the subject based on the second Gaussian-splat representation of the subject.

15. The apparatus of claim 14, wherein the additional images are rendered as if under different lighting conditions than lighting conditions in which the first input images of the subject were captured.

16. The apparatus of claim 13, wherein the second input images of the subject are based on different lighting conditions than the first input images of the subject.

17. The apparatus of claim 13, wherein each Gaussian splat of the second Gaussian-splat representation comprises position data, rotation data, scale data, color data, opacity data, normal data indicative of a normal vector of the Gaussian splat, Albedo color data, and spherical harmonic data.

18. A method for generating three-dimensional (3D) representations, the method comprising:
generating a Gaussian-splat representation of a subject based on a point-cloud representation of the subject; and
iteratively adjusting the Gaussian-splat representation and a mask indicative of Gaussian splats, of the Gaussian-splat representation to render images, by rendering images based on the Gaussian-splat representation and the mask, comparing the rendered images to input images of the subject, and adjusting parameters of the Gaussian-splat representation and values of the mask based on the comparison.

19. The method of claim 18, further comprising rendering additional images of the subject based on the Gaussian-splat representation of the subject.

20. The method of claim 19, wherein the additional images are rendered as if from different viewpoints than viewpoints from which the input images of the subject were captured.
